(19) United States
(12) Patent Application Publication
(10) Pub. No.: US 2015/0118520 A1
(43) Pub. Date: Apr. 30, 2015

(54) LOW RESISTANCE MAGNETIC SENSOR WITH EXTENDED PINNED LAYER STRUCTURE

(71) Applicant: HGST Netherlands B.V., Amsterdam (NL)

(72) Inventors: Yongchul Ahn, San Jose, CA (US); Xiaozhong Dang, Fremont, CA (US); Cherngye Hwang, San Jose, CA (US); Quang Le, San Jose, CA (US); Simon H. Liao, Fremont, CA (US); Guangli Liu, Pleasanton, CA (US); Stefan Maat, San Jose, CA (US)

(73) Assignee: HGST Netherlands B.V., Amsterdam (NL)

(21) Appl. No.: 14/062,789

(22) Filed: Oct. 24, 2013

(51) Int. Cl. G11B 5/33; G11B 5/31

(52) U.S. Cl. CPC G11B 5/332; G11B 5/3163
USPC 428/815; 204/192.34

(57) ABSTRACT

A magnetic read sensor having improved pinning and reduced area resistance. The sensor has pinned magnetic layer that extends beyond the functional stripe of the sensor to improve magnetic pinning. The free layer has a magnetic portion that extends to the functional stripe height and a non-magnetic portion that extends beyond the functional stripe height. The sensor may have an end point detection layer located between the magnetic pinned layer and the magnetic free layer.

### FIELD OF THE INVENTION

The present invention relates to magnetic data recording and more particularly to magnetic write head having an extended pinned layer structure and reduced area resistance.

### BACKGROUND OF THE INVENTION

The heart of a computer is an assembly that is referred to as a magnetic disk drive. The magnetic disk drive includes a rotating magnetic disk, write and read heads that are suspended by a suspension arm adjacent to a surface of the rotating magnetic disk and an actuator that swings the suspension arm to place the read and write heads over selected circular tracks on the rotating disk. The read and write heads are directly located, on a slider that has an air bearing surface (ABS). The suspension arm biases the slider into contact with the surface of the disk when the disk is not rotating, but when the disk rotates air is swirled by the rotating disk. When the slider rides on the air bearing, the write and read heads are employed for writing magnetic impressions to and reading magnetic impressions from the rotating disk. The read and write heads are connected to processing circuitry that operates according to a computer program to implement the writing and reading functions.

The write head includes at least one coil, a write pole and one or more return poles. When a current flows through the coil, a resulting magnetic field causes a magnetic flux to flow through the write pole, which results in a magnetic write field emitting from the tip of the write pole. This magnetic field is sufficiently strong that it locally magnetizes a portion of the adjacent magnetic disk, thereby recording a bit of data. The write field, then, travels through a magnetically soft under-layer of the magnetic medium to return to the return pole of the write head.

A magnetoresistive sensor such as a Giant Magnetoresistive (GMR) sensor or a Tunnel Junction Magnetoresisive (TMR) sensor can be employed to read a magnetic signal from the magnetic media. The magnetoresistive sensor has an electrical resistance that changes in response to an external magnetic field. This change in electrical resistance can be detected by processing circuitry in order to read magnetic data from the adjacent magnetic media. The sensor can include a magnetic pinned layer having a magnetization that is pinned in a first direction, a magnetic free layer that has a magnetization that is biased in a second direction that is generally orthogonal to the first direction and a non-magnetic barrier or spacer layer sandwiched between the pinned and free layers. The electrical resistance through the sensor layers varies in proportion to the relative orientations of the magnetizations of the free and pinned layer structures, and this change in resistance can be detected as a magnetic signal.

As the size of magnetic sensors becomes ever smaller, it becomes ever more difficult to construct a sensor that is reliable and robust. One challenge relates to pinning of the magnetization of the pinned layer structure. As the sensor becomes smaller, the pinned layer magnetization becomes less stable. Flipping of the magnetization of the pinned layer renders the sensor unusable. Therefore, there remains a need for a magnetic sensor design and method of manufacture that can provide a reliable, robust sensor even at very small sensor sizes.

### SUMMARY OF THE INVENTION

The present invention provides a magnetic sensor that includes a free layer structure, wherein a first portion of the free layer structure extends from an air bearing surface to a first stripe and a second portion of the free layer extends beyond the first stripe height, the first portion of the free layer structure being magnetic the second portion of the her layer structure being non-magnetic. The sensor also includes a magnetic pinned layer structure that extends beyond the first stripe height, and a non-magnetic layer sandwiched between the free layer structure and the pinned layer structure.

The sensor may also include an endpoint detection layer located between the pinned layer structure and the free layer structure. The end point detection layer can be constructed of a material having a long spin diffusion length, and can be located either above or below the non-magnetic layer, which can be either an electrically insulating barrier layer or an electrically conductive spacer layer.

Either the presence of the extended portion of the free layer or the presence of the end point detection layer serve to protect the pinned layer structure from damage during manufacturing. This thereby allows an extended pinned layer to be formed for improved pinning strength, while also minimizing area resistance of the sensor and preventing sensor performance degradation that might otherwise result from damage to the pinned layer structure.

These and other features and advantages of the invention will be apparent upon reading of the following detailed description of preferred embodiments taken in conjunction with the figures in which like reference numerals indicate like elements throughout.

### BRIEF DESCRIPTION OF THE DRAWINGS

For a fuller understanding of the nature and advantages of this invention, as well as the preferred mode of use, reference should be made to the following detailed description read in conjunction with the accompanying drawings which are not to scale.

FIG. 1 is a schematic illustration of a disk drive system in which the invention might be embodied;

FIG. 2 is an ABS view of a slider illustrating the location of a magnetic head thereon;

FIG. 3 is an air hearing surface vim of a magnetic read sensor according to an embodiment of the invention;

FIG. 4 is a side cross sectional view taken from line 4-4 of FIG. 3;

FIG. 5 is an air bearing surface view of a magnetic, read sensor according to an alternate embodiment of the invention;

FIG. 6 is a side cross sectional view of the magnetic sensor of FIG. 5 as seen from line 6-6 of FIG. 5;

FIG. 7 is an air bearing surface view of a magnetic sensor according to another embodiment of the invention;

FIGS. 8-18 are views of a magnetic read sensor in various intermediate stages of manufacture, illustrating a method of manufacturing a magnetic read sensor according to an embodiment of the invention; and

FIG. 19-27 are views of a magnetic read sensor in various intermediate stages of manufacture, illustrating a method of manufacturing a magnetic read sensor according to an alternate embodiment of the invention.

### DETAILED DESCRIPTION OF THE PREFERRED EMBODIMENTS

The following, description is of the best embodiments presently contemplated for carrying out this invention. This description is made for the purpose of illustrating the general principles of this invention and is not meant to limit the inventive concepts claimed herein.

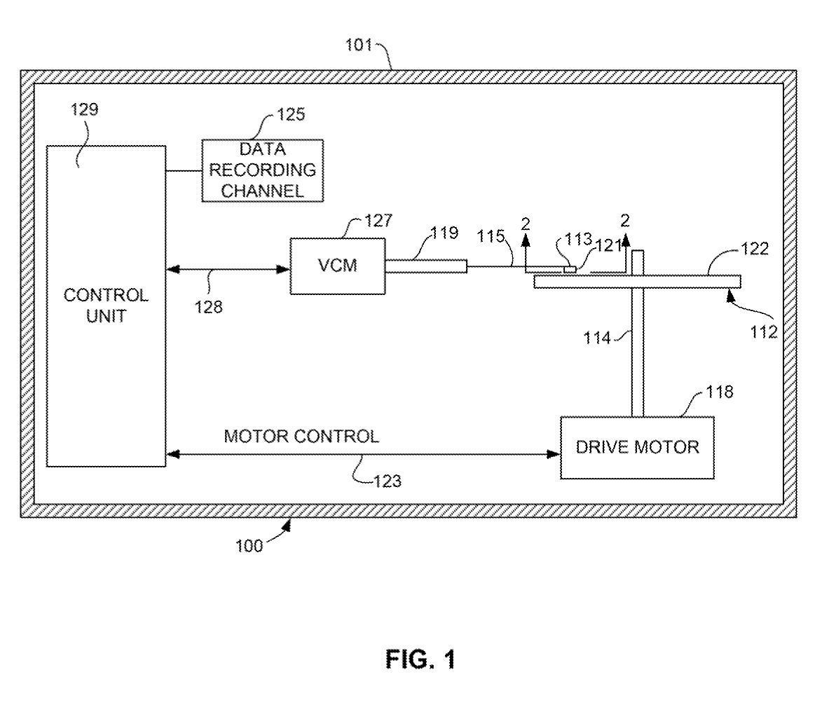

Referring now to FIG. 1, there is shown a disk drive 100 embodying this invention. The disk drive 100 includes a housing 101. At least one rotatable magnetic disk 112 is supported on a spindle 114 and rotated by a disk drive motor 118. The magnetic recording on each disk is in the form of annular patterns of concentric data tracks (not shown) on the magnetic disk 112.

At least one slider 113 is positioned near the magnetic disk 112, each slider 113 supporting one or more magnetic head assemblies 121. As the magnetic disk rotates, slider 113 moves in and out over the disk surf 122 so that the magnetic head assembly 121 can access different tracks of the magnetic disk where desired data are written. Each slider 113 is attached to an actuator arm 119 by way of a suspension 115. The suspension 115 provides a slight spring force which biases slider 113 against the disk surface 122. Each actuator arm 119 is attached to an actuator means 127. The actuator means 127 as shown in FIG. 1 may be a voice coil motor (VCM). The VCM comprises a coil movable within a fixed magnetic field, the direction and speed of the coil movements being controlled by the motor current signals supplied by controller 129.

During operation of the disk storage system, the rotation of the magnetic disk 112 generates an air bearing between the slider 113 and the disk surface 122 which exerts an upward force or lift on the slider. The air bearing thus counter-balances the slight spring force of suspension 115 and supports slider 113 of and slightly above the disk surface by a small, substantially constant spacing, during normal operation.

The various components of the disk storage system are controlled in operation by control signals generated by control unit 129, such as access control signals and internal clock signals. Typically, the control unit 129 comprises logic control circuits, storage means and a microprocessor. The control unit 129 generates control signals to control various system operations such as drive motor control signals on line 123 and head position and seek control signals on line 128. The control signals on line 128 provide the desired current profiles to optimally move and position slider 113 to the desired data track on disk 112. Write and read signals are communicated to and from write and read heads 121 by way of recording channel 125.

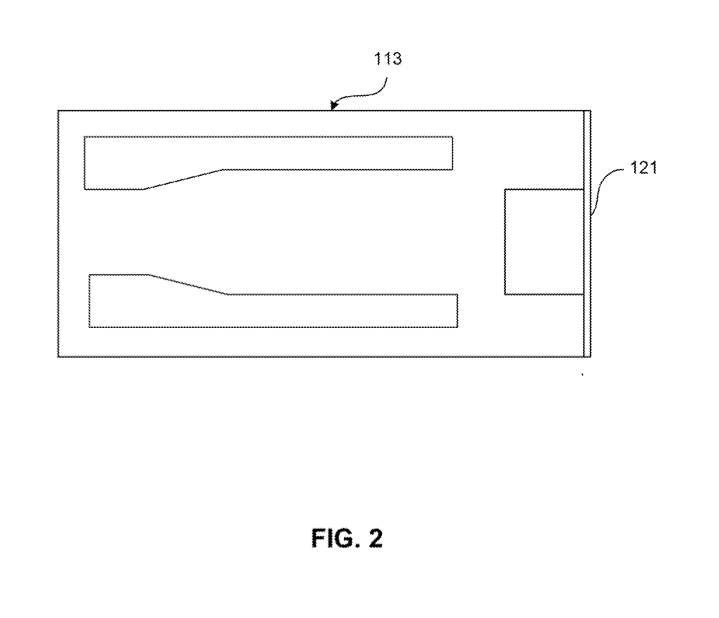

With reference to FIG. 2, the orientation of the magnetic head 121 in a slider 113 can be seen in more detail. FIG. 2 is an ABS view of the slider 113, and as can be seen the magnetic head including an inductive write head and a read sensor, is located at a trailing edge of the slider. The above description of a typical magnetic disk storage system and the accompanying illustration of FIG. 1 are for representation purposes only. It should be apparent that disk storage systems may contain a large number of disks and actuators, and each actuator may support a number of sliders.

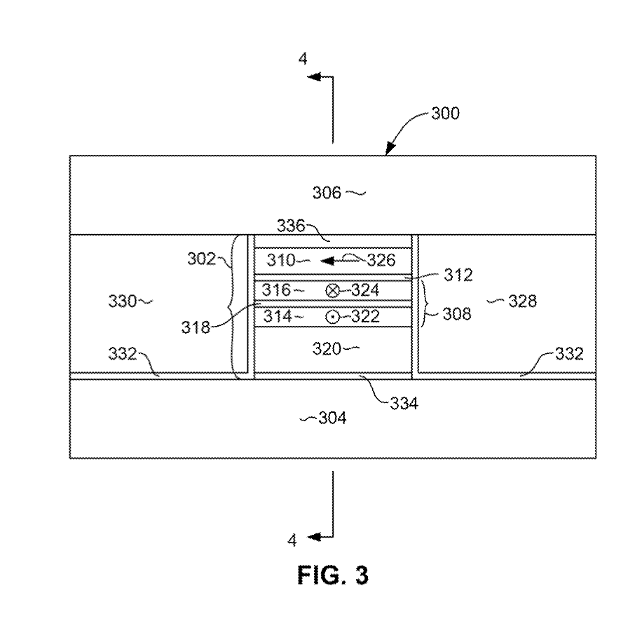

FIG. 3 shows a view of a magnetic read sensor 300 according to a possible embodiment of the invention as viewed from the air bearing surface. FIG. 3 shows a magnetic read sensor, 300 that includes a sensor stack 302 that is sandwiched between first and second magnetic shields 304, 306, The magnetic shields can be constructed of an electrically conductive, magnetic material such as NiFe so that they can function as electrical leads for supplying, a sense current to the sensor stack 302.

The sensor stack 302 can include a magnetic pinned layer structure 308, a magnetic free layer structure 310 and a non-magnetic barrier or spacer layer 312, sandwiched between the magnetic pinned layer structure 308 and magnetic free layer structure 310. If the sensor 300 is a giant magnetoresistive (GMR) sensor, then the layer 312 can be a non-magnetic, electrically conductive material such as Cu or AgSn. If the sensor 300 is a tunnel junction magnetic sensor (TMR), then the layer 318 can be a non magnetic, electrically insulating layer such as MgO.

The pinned layer structure 308 can be an anti-parallel pinned structure including a first magnetic layer (AP1) 314, a second pinned layer (AP2) 316 and a non-magnetic, anti-parallel coupling layer such as Ru 318 sandwiched between the first and second magnetic layers (AP1 and AP2 layers) 314, 316. The first magnetic layer 314 can be exchange coupled with a layer of antiferromagnetic material AFM layer 320, which can be a material such as IrMn or PtMn. This exchange coupling can be used to pin the magnetization of the first magnetic layer 314 in a first direction perpendicular to the air bearing surface as indicated by arrow head symbol 322. Anti-parallel coupling between the first and second magnetic layers 314, 316 pins the magnetization of the second magnetic layer 316 in a second direction that is perpendicular to the air bearing surface and anti-parallel with the first direction, as indicated by arrow tail symbol 324.

The magnetic free layer 310 has a magnetization that is generally oriented parallel with the air bearing surface as indicated by arrow 326, but that is free to move in response to an external magnetic field. The magnetization 326 can be biased by magnetic bias structures 328, 330 at either side of the sensor stack. The bias structures 328, 339 can be hard or soft bias structures, and can be separated from the sensor stack and from the bottom shield 304 by a thin insulation layer 332 such as alumina.

The sensor stack 302 can also include a seed layer 334 at its bottom. The seed layer can be provided to initiate a desired grain growth in the above formed layers. In addition, the sensor stack 302 can include a non-magnetic, electrically conductive capping layer 336 at its top above the free layer 310. The capping layer 336 can be used to protect the free layer 310 from damage or corrosion during manufacture of the sensor 300.

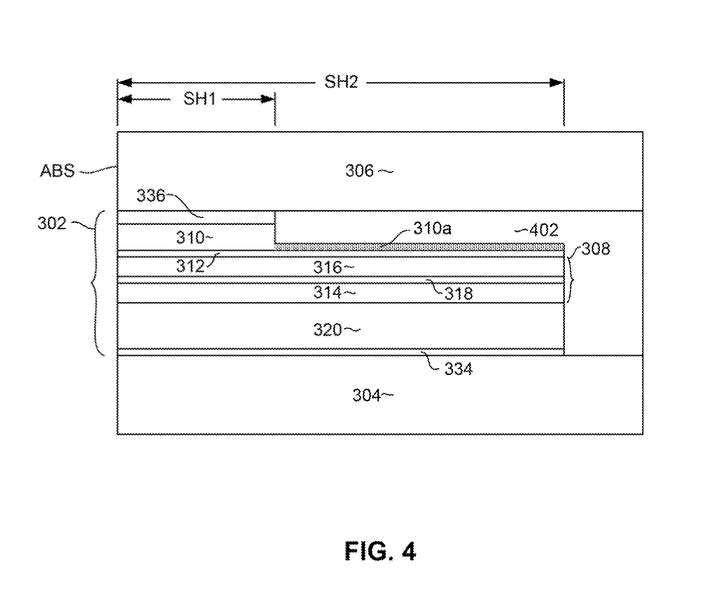

FIG. 4 is aside, cross sectional view as seen from line 4-4 of FIG. 3, In FIG. 4 it can be seen that a portion of the free layer structure 310 extends to a first stripe height SH1 as measured from the air bearing surface ABS, and a portion of the free layer 310a extends beyond the first stripe height SH1. The pinned layer structure 308 extends to the second stripe height SH2, also measured from the air bearing surface, the second stripe height SH2 being longer than the first stripe height SH1. The first stripe height SH1 defines the effective, magnetic stripe height of the sensor. However, the extended stripe height of the pinned layer structure 308 improves pinning strength of the pinned layer structure, As sensor size becomes smaller in order to provide increased data density, maintaining strong pinning of the pinned layer structure becomes more difficult. Extending the pinned layer as shown improves this pinned layer strength, thereby allowing for the production of a very small, high resolution magnetic sensor that is also reliable and robust.

The sensor 300 can be manufactured by various methods that will be described in greater detail herein below. However, it is desirable that the process for forming the sensor 300 with the extended pinned layer structure 308 does not damage the pinned layer structure and does not increase the area resistance of the sensor. In order to achieve this, the free layer 310 has a portion that extends beyond the first stripe height SH1, this extended portion is designated as 310a in FIG. 4. This extended portion 310a can be treated by a process that will be described herein below that renders this portion 310a non-magnetic, and electrically insulating. Therefore, this portion 310a of the free layer 310 does not contribute to the functional magnetic stripe, allowing high resolution to be maintained. This extended free layer portion 310a can be constructed of a magnetic material that has been doped with a material such as nitrogen (N) or oxygen (O). Therefore, the extended portion 310a can be constructed of one or more layers of material such as CoFe, NiFe, and/or a Heusler alloy with trace amounts of a doping material such as N or O that render the material non-magnetic and oxidized. The presence of the extended free layer portion 310a protects the pinned layer structure 308 for reasons that will be more apparent upon review of a method for manufacturing the sensor as discussed herein below.

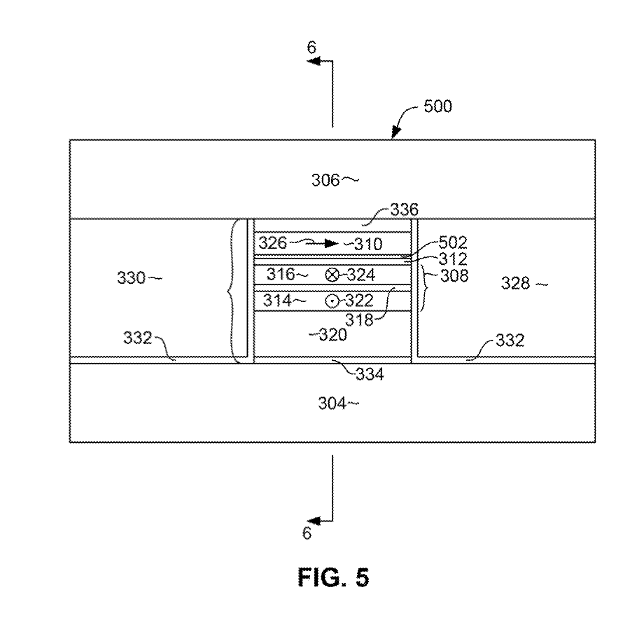

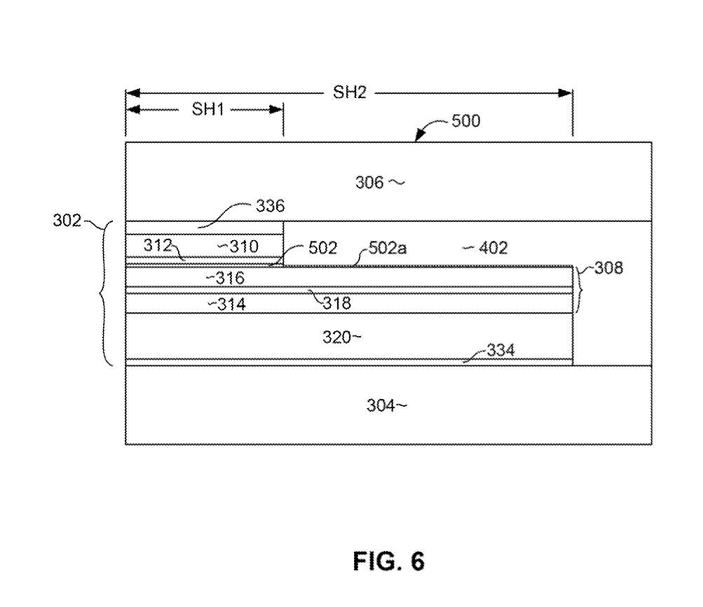

FIGS. 5 and 6 illustrate a read sensor according to another possible embodiment of the invention. FIG. 5 is an air bearing surface view and FIG. 6 is a side cross sectional view as seen from line 6-6 of FIG. 5. FIGS. 5 and 6 illustrate a sensor 500 that includes an end point detection layer 502 located between the spacer/barrier layer 312 and the free layer 310. This endpoint detection layer 502 is constructed of a material that has a high spin diffusion length and that is also easily detectable by a process such as secondary ion mass spectrometry (SIMS). The end point detection layer 502 does not function as a part of the barrier/spacer layer 312, and therefore does not affect sensor performance in that way. To this end, the endpoint detection layer 502 can be constructed of a material such as Ag, Mg, Cu, or Au for a sensor having an electrically insulating barrier layer 312 or MgO or CuO for a sensor with an electrically conductive spacer layer 312.

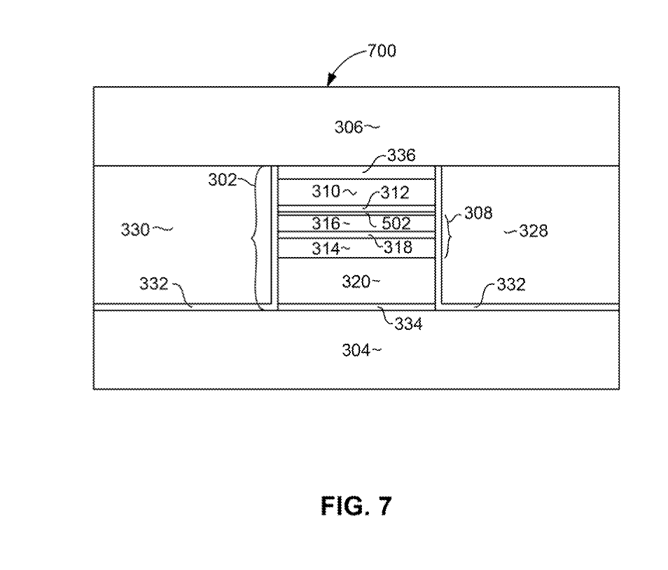

FIG. 7 is an air bearing surface view of a magnetic sensor 700 according, to another embodiment. The sensor 700 of FIG. 7 is similar to the sensor 500 of FIGS. 5 and 6, except that in the sensor 700, the non-magnetic, electrically conductive, high spin polarization length end point detection layer 502 is located beneath the spacer/barrier layer 312, between the spacer barrier layer 312 and the AP2 layer 316. In this embodiment, the layer 502 itself can be used to protect the AP2 layer 316 during manufacture, as will be seen herein below.

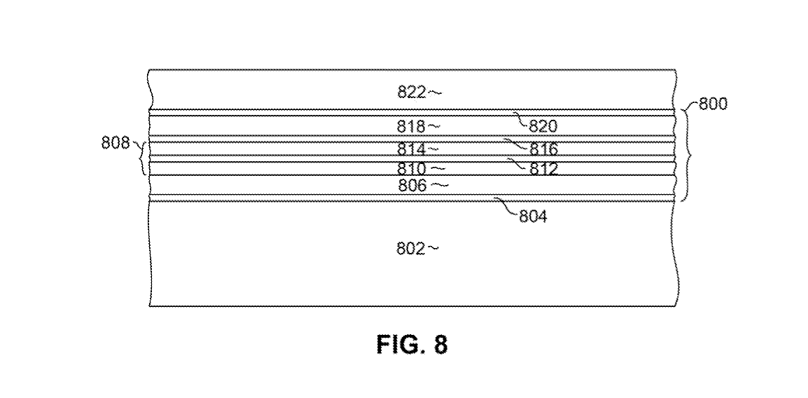

FIGS. 8-18 show a magnetic read sensor in various intermediate stages of manufacture, illustrating a method for manufacturing a magnetic read sensor according to an embodiment of the invention. With particular reference to FIG. 8, an electrically conductive, magnetic shield 802 is formed, having a smooth flat upper surface. A series of sensor layers 800 is deposited over the shield. The series of sensor layers 800 can include: a seed layer 804; a layer of antiferromagnetic material (AFM) layer 806, such as IrMn or PtMn; a pinned layer structure 808 formed over the AFM layer 806; a non-magnetic spacer or barrier layer 816 formed over the pinned layer structure 808; a free magnetic layer 818 formed over the barrier/spacer layer 816 and a capping layer 820 formed over the free magnetic layer 818. The pinned layer structure 808 can include: a first magnetic layer (AP1) 810 a non-magnetic anti-parallel coupling layer such as Ru 812 formed over the AP1 layer 810; and a second magnetic layer (AP2) 814 formed over the anti-parallel coupling layer 812. A mask material 822 can be formed over the sensor layers 890. The mask material 822 can include a photoresist material but can include other layers as well such as one or more hard mask layers, an image transfer layer, an anti-reflective coating, etc. (not shown).

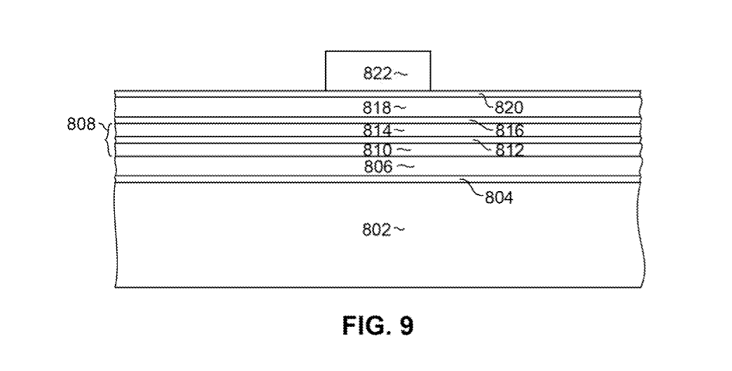

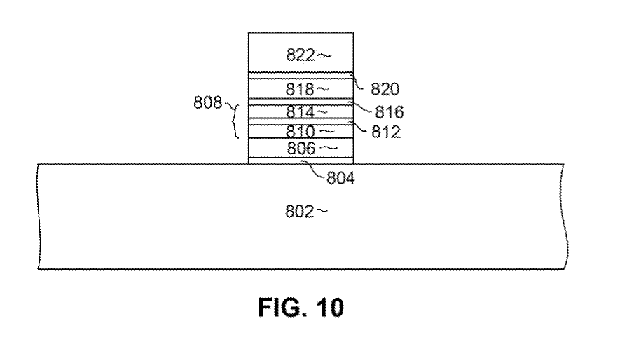

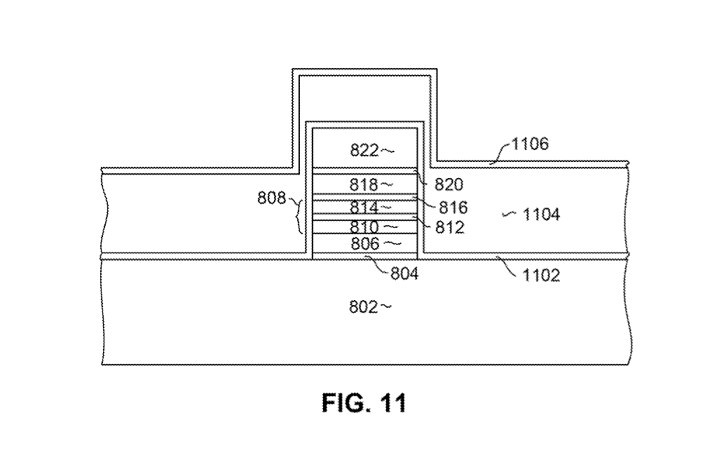

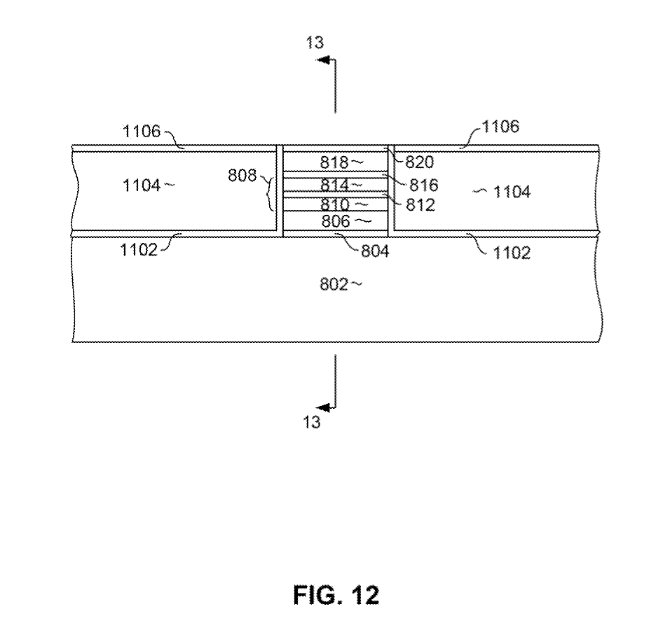

Then, with reference to FIG. 9, the mask 822 is photolithographically patterned so as to define a track width defining mask shape 822. An ion milling is then performed to remove portions of the sensor material 800 that are not protected by the mask 822, leaving a structure as shown in FIG. 10. Then, with reference to FIG. 11, a thin insulation layer such as alumina 1102 is deposited, followed by a magnetic bias structure 1104, followed by a capping/CMP stop layer 1196. The layer 1106 is preferably constructed of a material that is resistant to removal by chemical mechanical polishing, such as Ru, carbon, etc. A chemical mechanical polishing and/or chemical liftoff process can then be performed to remove the mask 822 and planarize the structure, leaving a structure as shown in FIG. 12.

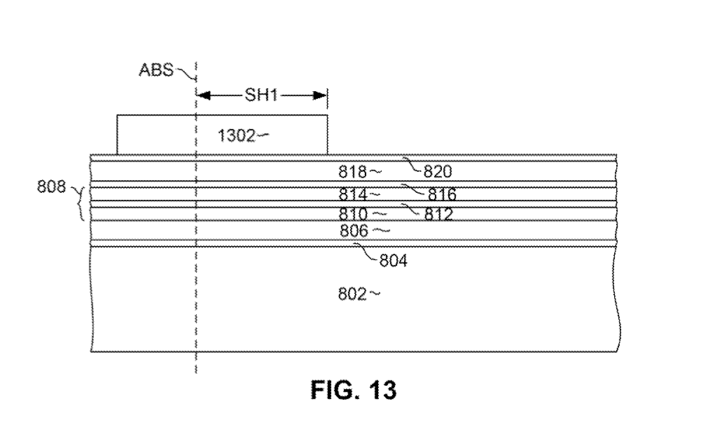

FIG. 13 shows a side cross sectional view as seen from line 13-13 of FIG. 12. As shown in FIG. 13. a second mask 1302 is formed. As before, the mask 1302 can include a photolithographically patterned photoresist, but can also include other layers such as one or more hard mask layers, an image transfer layer, a bottom anti-reflective coating (BARC), etc. The mask 1302 is patterned so that it has a back edge that is located a desired distance from an air bearing surface plane ABS so as to define a first stripe height (SH1) as measured from the ABS plane.

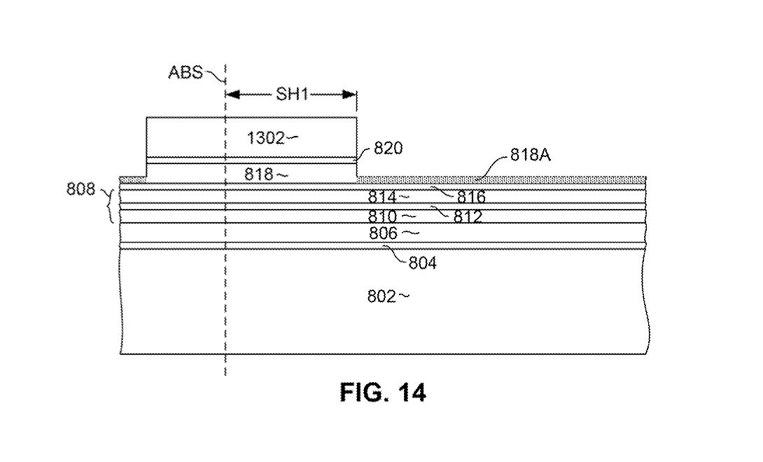

Then, with reference to FIG. 14, an ion milling is performed to remove portions of the capping layer 820 and a portion of the free layer 818 that are not protected h the mask 1302. The ion milling, is terminated before the underlying spacer/barrier layer 816 has been exposed. That is to say, the ion milling is terminated before all of the free layer 818 has been removed from the area beyond the mask 1302. This ensures that the under-lying barrier/spacer 816 and AP2 layer 814 will not be damages by the ion milling. This, thereby, leaves a portion 818a extending beyond the first stripe height SH1.

With continued reference to FIG. 14, after the ion milling has been terminated, a process is performed to render the extended portion 818a of the free layer 818 magnetic and oxidized. This process can include exposing the layer 818a to oxygen O₂ or nitrogen N. By rendering this extended portion of the free layer 818a non-magnetic and oxidized, this portion does not contribute to the magnetic functioning of the sensor, and the functional magnetic stripe height of the sensor remains limited to the stripe height distance SH1, even though the extended portion of the free layer 818a remains to protect the under-lying layers from being damaged by the above described ion milling.

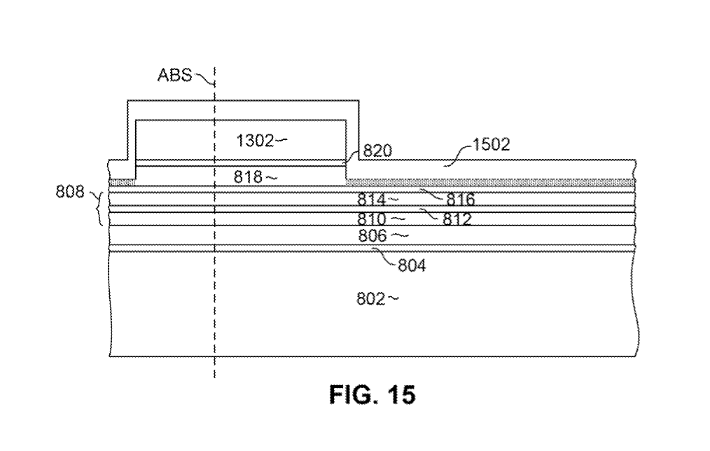

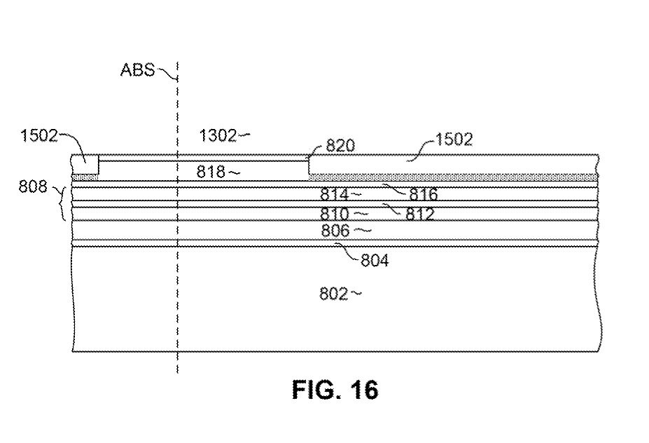

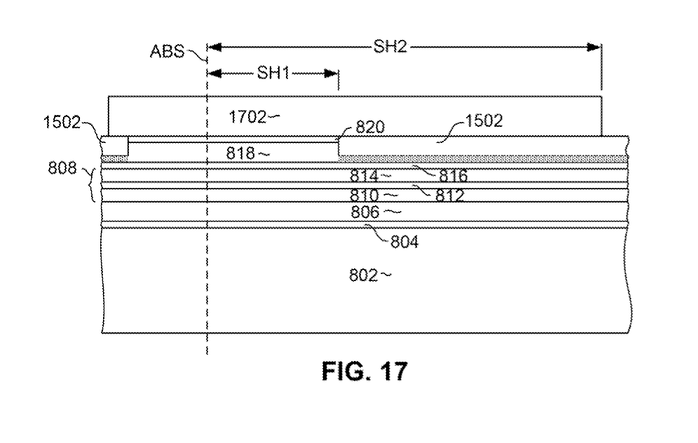

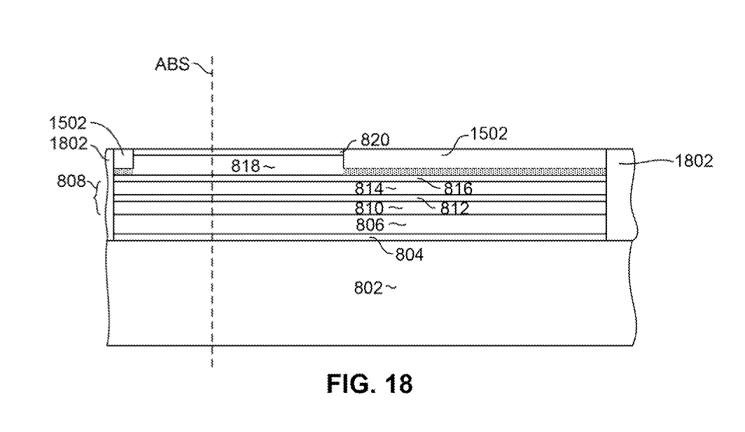

Then, with reference to FIG. 15, a non-magnetic, electrically insulating fill layer such as alumina 1502 is deposited. Another chemical mechanical polishing process (CMP) is then performed to planarize the structure and expose the sensor layer 820, leaving a structure as shown in FIG. 16. With reference to FIG. 17, a third mask 1702 is formed with an edge that is configured to define a second stripe height (SH2) that is longer than the first stripe height (SH1). Then, another ion milling can be performed to remove portions of the pinned layer structure 808 that are not protected by the third mask 1702. Another non-magnetic, electrically insulating till material 1802 can then be deposited, and another planarization process such as chemical mechanical polishing can be performed to remove the mask 1702, leaving a structure as shown in FIG. 18.

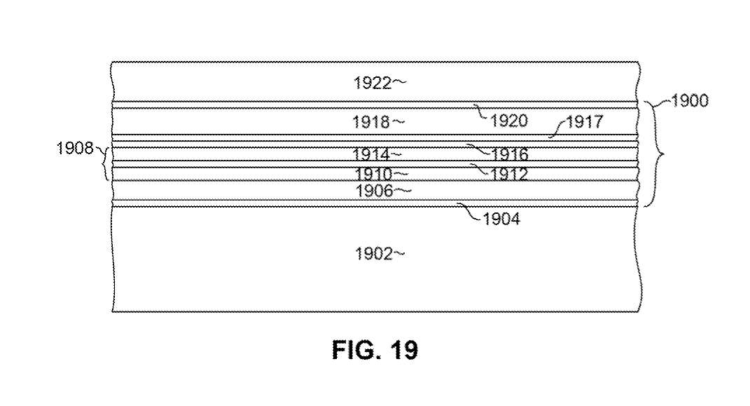

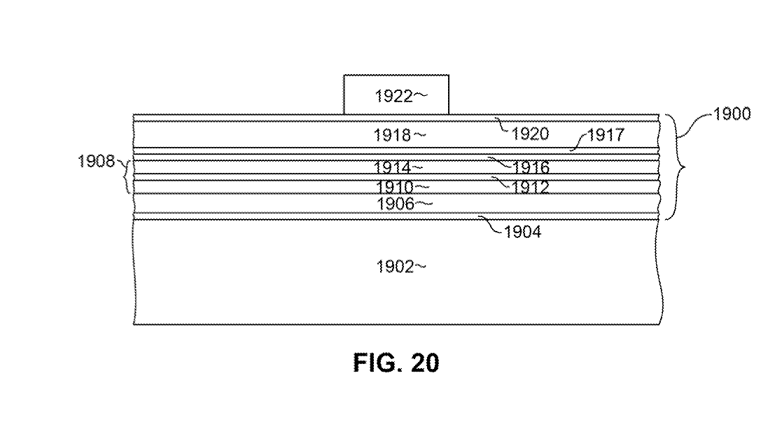

FIGS. 19-27 show a magnetic sensor in various intermediate stages of manufacture, illustrating a method for manufacturing a magnetic read sensor according to another embodiment. With particular reference to FIG. 19, bottom magnetic shield 1902 is provided. The shield 1902 is formed of an electrically conductive, magnetic material so that it can function as an electrically conductive lead as well as a magnetic shield. A series of sensor layers 1900 is deposited over the shield 1902. The series of sensor layers 1900 can include: a seed layer 1904; an AFM layer 1906 formed over the seed 1904; a pinned layer structure 1908 formed over the AFM layer 1906; a spacer or barrier layer 1916 formed over the pinned layer structure 1908; an end-point detection layer 1917 formed over the spacer/barrier layer 1916; a magnetic free layer 1918 formed over the end point detection layer 1917; and a capping liner 1920 formed over the magnetic, free layer 1918. The pinned layer structure 1908 can include: a first magnetic layer (AP1) 1910; a second magnetic layer (AP2) 1914 and a non-magnetic anti-parallel coupling layer 1912 sandwiched between the AP1 and AP2 layers 1910, 1914. A mask layer 1922 is formed over the series of sensor layers 1900. The mask layer 1922 can include a photoresist, but can also include other layers such as a hard mask, an image transfer layer, a bottom anti-reflective coating (BARC), etc (not shown).

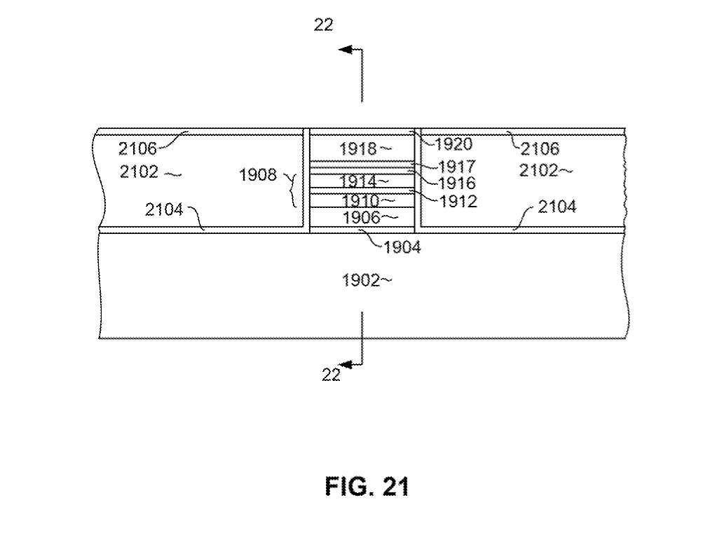

With reference to Fie. 20, the first mask 1922 is patterned as shown to define a sensor track-width. Then, an ion milling is performed to remove portions of the series of sensor layers 1900 that are not protected by the mask 1922 to define a sensor track-width. An insulation layer 2104, magnetic bias material 2102, and CMP stop layer/bias capping layer 2106 are deposited and a chemical mechanical polishing is performed, leaving a structure as shown in FIG. 21.

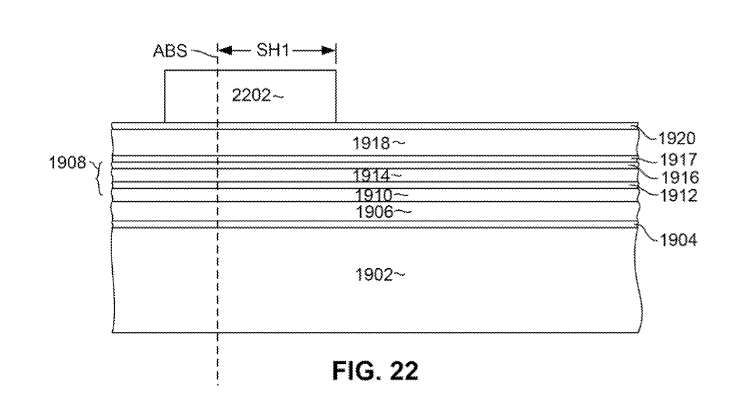

FIG. 22 shows a side cross sectional view as seen from line 22-22 of FIG. 21. A second mask 2202 is formed. As before, the mask 2202 can include a photoresist material and can also include other materials such as one or more hard mask layers, an image transfer layer, a bottom anti-reflective coating, etc. The mask 2202 is photolithographically patterned to form a mask structure having a back edge located a desired distance from an air bearing surface plane (ABS) so as to define a first stripe height SH1.

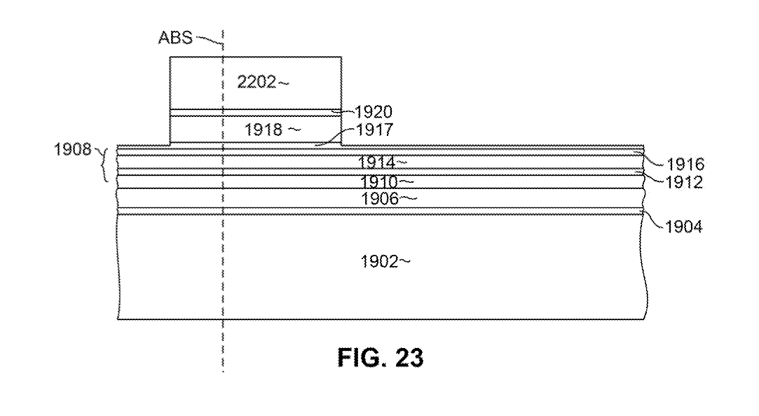

With reference to FIG. 23, an ion milling, is performed to remove portions of the free layer 1918 and capping layer 1920 that are not protected by the mask 2202. The ion milling is terminated when the end-point detection layer 1917 is reached. The end-point detection layer 1917 is constructed of a material that can be easily detected during, ion milling, but which also can be left in the finished read sensor without affecting magnetic performance of the sensor To this end, the end-point detection layer 1917 is formed of a material having a long spin diffusion length, and that is also non-magnetic, and electrically conductive. Suitable materials for the end point detection layer include Ag, Mg, Cu, and Au for sensor with an electrically insulating barrier layer 1916, or MgO, CuO for sensor with an electrically conductive spacer layer 1916. By stopping the ion milling when the end point detection layer 1917 is reached, a portion of the end point detection layer 1917 can remain in the portion extending beyond the free layer 1918,

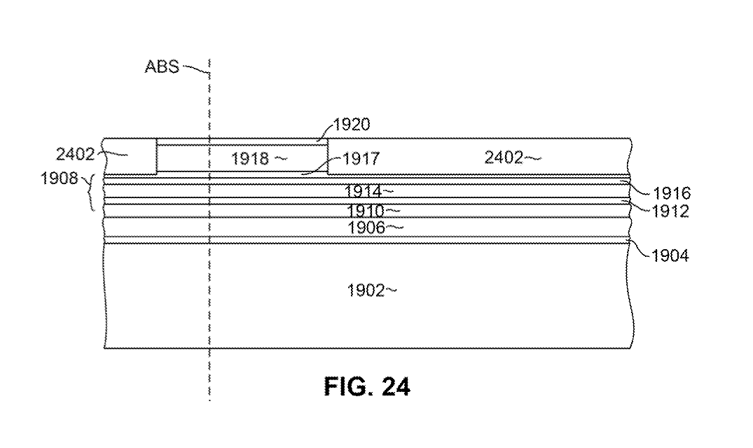

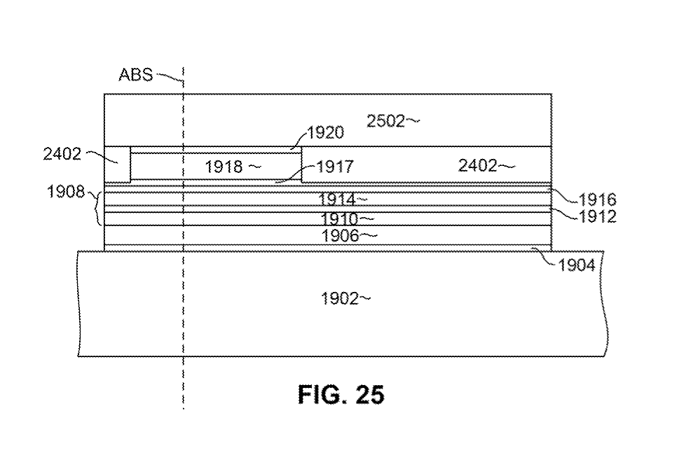

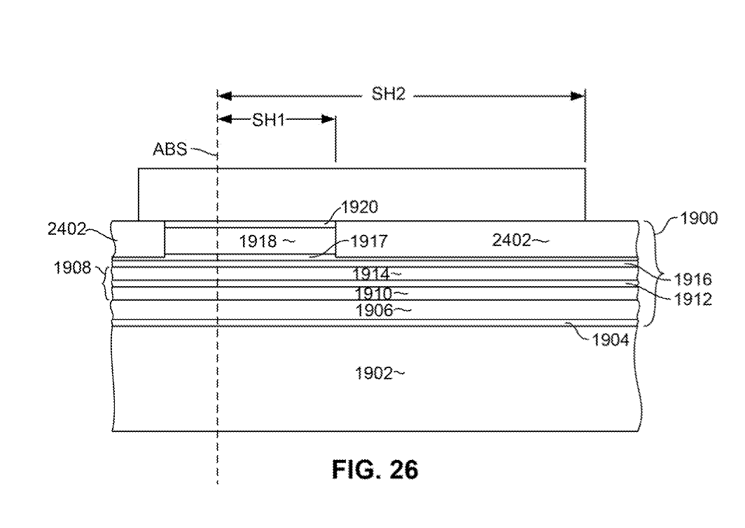

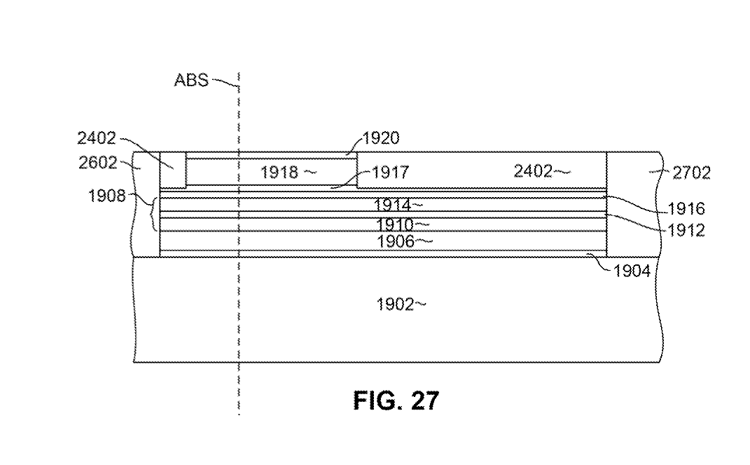

A non-magnetic, electrically insulating material 2402 is deposited and a chemical mechanical polishing process is performed, leaving a structure as shown in FIG. 24. Then, with reference to FIG. 25, a third mask 2502 is formed to define a second stripe height SH2 that is longer than the first stripe height SH1. Then, with reference to FIG. 26 another on milling is performed to remove the remainder of the series of sensor layers 1900 that are not protected by the mask 2502. A non-magnetic. electrically insulating material 2702 can then be deposited and chemical mechanical polishing process can h performed to form, leaving a structure as shown in FIG. 27.

It should be pointed out, also, that rather than depositing the end point detection layer over the spacer/barrier layer 1916, the end point detection layer could be deposited between the AP2 layer 1914 and space barrier layer 1916. This would result in a structure as shown in FIG. 7.

While various embodiments have been described above, it should be understood that they have been presented by way of example only and not limitation. Other embodiments falling within the scope of the invention may also become apparent to those skilled in the art. Thus, the breadth and scope of the invention should not be limited by any of the above-described exemplary embodiments, but should be defined only in accordance with the following claims and their equivalents.

1. A magnetic sensor, comprising:
a free layer structure, wherein a first portion of the free layer structure extends from an air bearing surface to a first stripe the first portion of the free layer structure being magnetic, and a second portion of the free layer structure extends beyond the first stripe height, the second portion of the free layer structure being non-magnetic;
a magnetic pinned layer structure extending beyond the first stripe height; and
a non-magnetic layer sandwiched between the free layer structure and the pinned layer structure.

2. The magnetic sensor as in claim 1, wherein the second portion of the free layer structure is doped with oxygen.

3. The magnetic sensor as in claim 1, wherein the second portion of the free layer structure is doped with nitrogen.

4. The magnetic sensor as in claim 1, wherein the non-magnetic pinned layer structure, non-magnetic layer and the second portion of the free layer extend to a second stripe height that is longer than the first stripe height.

5. The magnetic sensor as in claim 1, wherein the first portion of the free layer is thicker than the second portion of the free layer.

6. The magnetic sensor as in claim 1, wherein the free layer comprises a magnetic material and wherein the second portion of the free layer has been treated so as to render it non-magnetic.

7. A magnetic sensor, comprising:
a magnetic free layer structure extending to a first stripe height;
a magnetic pinned layer structure extending to a second stripe height that is longer than the first stripe height;
a non-magnetic layer located between the pinned layer structure and the magnetic free layer structure; and
an endpoint detection layer also located between the magnetic free layer structure and the magnetic pinned layer structure.

8. The magnetic sensor as in claim 7 wherein the endpoint detection layer comprises a material having a long spin diffusion length.

9. The magnetic sensor as in claim 7 wherein the non-magnetic layer is an electrically insulating barrier layer and the endpoint detection layer comprises Ag, Mg, Cu, or Au.

10. The magnetic sensor as in claim 7 wherein the non-magnetic layer is an electrically conductive spacer layer and the endpoint detection layer comprises MgO or AgO.

11. The magnetic sensor as in claim 7, wherein the endpoint detection layer is non-magnetic.

12. The magnetic sensor as in claim 7, wherein the endpoint detection layer located between the magnetic free layer and the non-magnetic layer.

13. The magnetic sensor as in claim 7, wherein the endpoint detection layer is located between the magnetic pinned layer structure and the non-magnetic layer.

14. The magnetic sensor as in claim 7, wherein a first portion of the endpoint detection layer extends to a first stripe height and a second portion of the endpoint detection layer extends to a second stripe height, the first portion being thicker than the second portion.

15. A method for manufacturing a magnetic sensor, comprising:
depositing a series of sensor layers including a pinned layer structure a non-magnetic layer deposited over the pinned layer structure and a magnetic free layer structure deposited over the non-magnetic layer;
forming a first mask having an edge configured to define a first stripe height;
performing an ion milling to remove a portion of the free layer that is not protected by the first mask, the ion milling being terminated before the magnetic free layer has been completely removed, thereby leaving an extended portion of the magnetic free layer that extends beyond the first stripe height; and
performing a process to render the extended portion of the free layer non-magnetic.

16. The method as in claim 15, wherein the process to render the extended portion of the free layer non-magnetic comprises exposing the extended portion of the free layer to oxygen.

17. The method as in claim 15, wherein the process to render the extended portion of the free layer non-magnetic comprises exposing the extended portion of the free layer to nitrogen.

18. The method as in claim 15 further comprising, after performing a process to render the extended portion of the free layer non-magnetic, forming a second mask having an edge configured to define a second stripe height that is longer than the first stripe height, and performing a second ion milling to remove portions of the magnetic pinned layer structure that are not protected by the second mask.

19. A method for manufacturing a magnetic read sensor, comprising:
depositing a series of sensor layers including a pinned layer structure, a non-magnetic layer, an endpoint detection layer and a free layer structure, the free layer structure and end point detection layer being deposited after the pinned layer structure;
forming a mask having an edge configured to define a stripe height; and
performing an ion milling to remove a portion of the sensor material that is not protected by the end point detection layer, the ion milling being terminated when the end point detection layer has been reached.

20. The method as in claim 19, wherein the end point detection layer has a long spin diffusion length.

21. The method as in claim 19, wherein the end point detection layer comprises Ag, Mg, Cu, Au, AgO or MgO.

22. The method as in claim 19, wherein the end point detection layer is deposited after deposition of the non-magnetic layer and before deposition of the free layer structure.

23. The method as in claim 19, wherein the end point detection layer is deposited before deposition of the non-magnetic layer and before deposition of the free layer structure.

24. The magnetic sensor as in claim 1 further comprising an endpoint detection layer located between the magnetic free layer structure and the magnetic pinned layer structure.

25. The magnetic sensor as in claim 1 further comprising an endpoint detection layer located between the magnetic free layer structure and the magnetic pinned layer structure, wherein the endpoint detection layer comprises a material having a long spin diffusion length.
